(19) United States
(12) Patent Application Publication
(10) Pub. No.: US 2013/0085000 A1
(43) Pub. Date: Apr. 4, 2013

(54) STRUCTURAL WALL APPARATUS AND METHOD FOR A GAMING MACHINE

(71) Applicants: Patrick J. Nohr, Reno, NV (US); Tai Rosander, Reno, NV (US); Jamison Frady, Reno, NV (US)

(72) Inventors: Patrick J. Nohr, Reno, NV (US); Tai Rosander, Reno, NV (US); Jamison Frady, Reno, NV (US)

(73) Assignee: INTERNATIONAL GAME TECHNOLOGY, Las Vegas, NV (US)

(21) Appl. No.: 13/287,850

(22) Filed: Nov. 2, 2011

Related U.S. Application Data
(60) Provisional application No. 61/541,840, filed on Sep. 30, 2011.

(51) Int. Cl. A63F 13/08

(52) U.S. Cl. 463/46

(57) ABSTRACT

A gaming machine includes an outer housing and an inner housing. The outer housing includes a first wall having a first ventilation port in fluid connection exterior to the outer housing. The inner housing within the outer housing includes a second wall including a second ventilation port. The second ventilation port is offset from the first ventilation port. The gaming machine also includes a player input/output accessible through the outer housing, and circuitry for gaming within the inner housing and operably connected to the player input/output.

### TECHNICAL FIELD

Various embodiments described herein relate to a gaming machine having an exterior wall and an interior wall with a gap or space therebetween, and a method for using the same.

### BACKGROUND

Electronic and microprocessor based games are becoming increasingly popular. In an electronic gaming machine, a player initiates game play by making a wager. The electronic gaming machine, or microprocessor associated with the electronic gaming machine, determines the result of play and displays it to the game player. Upon winning, the game player is credited with the winnings. At anytime, the game player has the option to “cash out” the winnings or whatever balance remains. Nowadays, a ticket is printed indicative of the winning amount. A player prints the ticket and takes it to another portion of the casino where the ticket is verified and the payout is made to the player. With the increasing popularity of these games, security is becoming more important.

Electronic gaming machines have a cabinet in which the microprocessor and other hardware are housed that are the main portion of a game. The cabinet has a lockable door to prevent unauthorized entry to the space that includes the brain box (microprocessor, memory, and other electrical element), long term storage, and a cash box which holds both bills and tickets. The cabinets must be spill resistant. People playing the electronic gaming machines may do so while enjoying a beverage. A beverage set on or near an electronic gaming machine can spill unintentionally. If the player is not winning some players may become upset and spill the beverage with some level of intention. Therefore, the cabinets must be able to handle spills without posing a threat to ruining the components within the cabinets.

It should also be remembered that the gaming industry, which includes casinos, is a growing, multi-billion dollar, world-wide industry. Large amounts of money can be involved in game play. Individual machines can pay out large amounts. Electronic machines involved in progressive game play, where a large number of players are involved from multiple casinos, can have huge payouts. When such large amounts are at stake, people are tempted to cheat or steal from a system. Generally, some form of access must be gained to an electronic gaming machine to cheat or steal from the machine.

A mode of theft for gaming machines involves accessing the devices which control the input and output of money to the gaming machine through some access mechanism and manipulating the devices in some manner to obtain an illegal payout. For example, one type of theft might involve simply taking money from a drop box while a gaming machine is being accessed for maintenance. Another type of theft might involve illegally gaining access to the master gaming controller and reprogramming the master gaming controller to pay out an illegal jackpot. Another type of theft might involve compromising the wires to a coupon dispenser and sending the coupon dispenser a signal instructing it to dispense coupons with some monetary value.

One method for preventing theft is installing a security system which monitors the various access mechanisms of a gaming machine. Typically security devices of this type monitor access to the various entry ports within the gaming machine as well as the wires to some gaming devices. One potential access point for a thief, or cheat, may be through vent openings in an electronic gaming machine. A microprocessor or microcontroller used to run an electronic gaming machine produces heat. The heat must be removed. Most systems are air-cooled. In an air-cooled system, the cabinet generally includes vent openings in the sidewalls of the electronic gaming machines. Most generally have one vent opening for incoming air and another for exit of warm air. The vent openings in some machines may be a weak link in the security of a particular machine. In other words, this may be one point where thieves could more easily gain access to the brain box or main portion of the machine that controls many aspects of a game, including odds for winning and payouts.

Another access point is where there is wiring that might go from one part of the electronic gaming machine to another part of the gaming machine. For example, some wires might be exposed between the cabinet and the top box. The wires could be used to access some of the electronic components in the cabinet to alter payouts or tilt the odds. In addition, when maintaining an electronic gaming machine, it would be helpful in preventing theft if wires coupled to the brain box could be accessed without having to open the cabinet where the brainbox is located. For example, if a component asscociated with the top box had to be fixed, it would be more secure if the cabinet did not also have to be opened. This would lessen the temptation to cheat or outright steal.

### SUMMARY OF THE DESCRIBED EMBODIMENTS

A gaming machine includes an outer housing including side walls and an inner housing being fixed within the outer housing. The gaming machine also includes a player input/output. The player input/output is accessible through the outer housing. The gaming machine also includes circuitry for gaming within the inner housing that is operably connected to the player input/output. The outer housing has at least one side wall having a first inlet in fluid connection exterior to the outer housing, and at least one side wall having a first internal ventilation port in fluid connection with the first inlet. The first internal port is offset from the first inlet in the outer housing. The inner housing can also include additional internal ventilation ports. For example, the internal housing can have a second internal ventilation port and third internal ventilation port. The second port and the third port, in one embodiment, are offset from the first port and offset from each other.

A gaming machine includes an outer housing and an inner housing. The outer housing includes a first wall having a first ventilation port in fluid connection exterior to the outer housing. The inner housing within the outer housing includes a second wall including a second ventilation port. The second ventilation port is offset from the first ventilation port. The gaming machine also includes a player input/output accessible through the outer housing, and circuitry for gaming within the inner housing and operably connected to the player input/output. The first ventilation port and the second ventilation port are connected by a duct to convey fluid. In one embodiment, the first ventilation port is positioned rearwardly of the second ventilation port. In another embodiment, the first ventilation port is positioned downwardly of the second ventilation port. The outer housing and the inner housing form a gap therebetween, the gap providing at least one of liquid protection for the circuitry for gaming or air flow for the circuitry for gaming. The inner housing includes a fan to draw air through the first ventilation port from outside the outer housing into the gap between the outer housing and the inner housing. The air is then drawn into the inner housing through the second ventilation port. The fan also moves the air or fluid through the housing and out the inner housing and outer housing. In one embodiment, the gap between the inner housing and the outer housing includes a raceway to hold wiring. The gap also includes a cooling system, in some embodiments. The gap can also include an antenna for wireless communication with external circuitry. In some embodiments, the outer housing and the inner housing both operate as structural supports.

In one embodiment, the first ventilation port has fewer apertures than the second ventilation port. In some embodiments, the first wall and the second wall do not face each other. The first wall is positioned on a side or rear of the gaming machine. In another embodiment, the second wall is positioned on a side or front of the gaming machine.

A method for maintaining an electronic gaming machine having an outer housing positioned within an inner housing that carries gaming circuitry which includes a microprocessor, memory and a plurality of peripheral devices coupled to the microprocessor is described herein. The method includes removing the inner housing from the outer housing; placing a replacement inner housing into the outer housing, and coupling the peripheral devices outside the inner housing to the gaming circuitry. Removing the inner housing includes uncoupling fasteners from the outer housing unlatching the inner housing from the outer housing.

### BRIEF DESCRIPTION OF THE DRAWINGS

The embodiments will be readily understood by the following detailed description in conjunction with the accompanying drawings, wherein like reference numerals designate like structural elements, and in which:

FIG. 1 is a perspective view of an electronic gaming machine apparatus, according to an embodiment of the invention.

FIG. 2 shows a schematic diagram of a cabinet of an electronic gaming apparatus, according to an example embodiment.

FIG. 3 is a cross-sectional view of the housing of an electronic gaming machine along cut line 3-3 in FIG. 1, according to an example embodiment.

FIG. 4 is a perspective view of a wall of an electronic gaming machine that shows a vent opening on the inner wall and a vent opening on an outer wall of a cabinet, according to an example embodiment.

FIG. 5 is a cross-sectional view of a double wall cabinet for an electronic gaming machine, according to an example embodiment.

FIG. 6 is a side view of an inner wall and an outer wall having vent openings, according to another example embodiment.

FIG. 7 is a cross-sectional view of the housing of an electronic gaming machine along cut line 7-7 in FIG. 1, according to an example embodiment.

FIG. 8 is a perspective view of a corner of the housing shown in FIG. 7, according to an example embodiment.

FIG. 9 is a schematic diagram showing multiple gaming machines on a gaming floor with signage supported by the structural supports in the cabinets, according to an example embodiment.

FIG. 10 is another top cross-sectional view along cut line 7-7 of FIG. 1 which shows a wire routing structure in the cabinet, according to an example embodiment.

FIG. 11 is side view a wall of the housing of the cabinet, wherein the gap between the inner wall and the outer wall includes an antenna for wireless communication with external circuitry, according to an example embodiment.

FIG. 12 is side view a wall of the housing of the cabinet, wherein the gap between the inner wall and the outer wall includes a cooling system, according to an example embodiment.

FIG. 13 is side view a wall of the housing of the cabinet, wherein the gap between the inner wall and the outer wall includes a duct, according to an example embodiment.

FIG. 14 shows a schematic diagram of a computer system used in the gaming system, according to an example embodiment.

### DETAILED DESCRIPTION

In the following paper, numerous specific details are set forth to provide a thorough understanding of the concepts underlying the described embodiments. It will be apparent, however, to one skilled in the art that the described embodiments may be practiced without some or all of these specific details. In other instances, well known process steps have not been described in detail in order to avoid unnecessarily obscuring the underlying concepts.

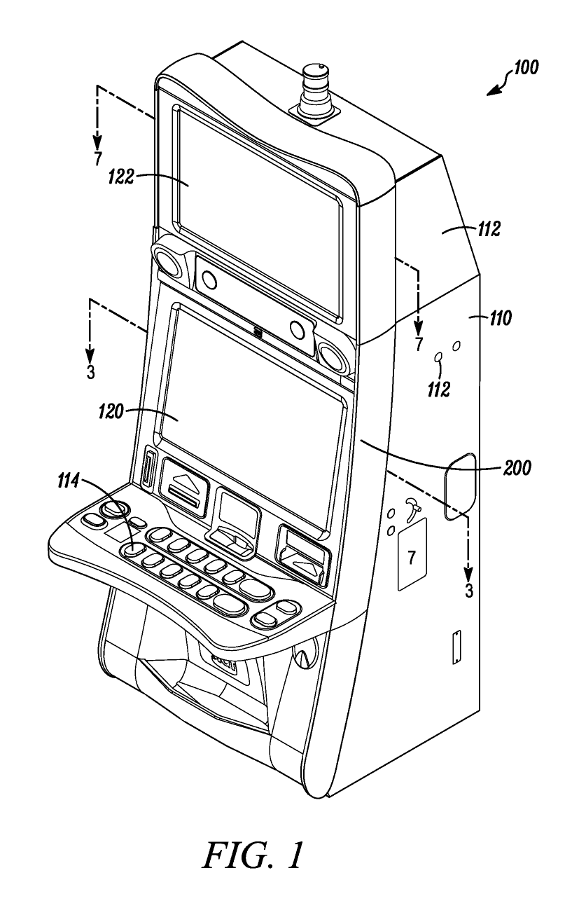

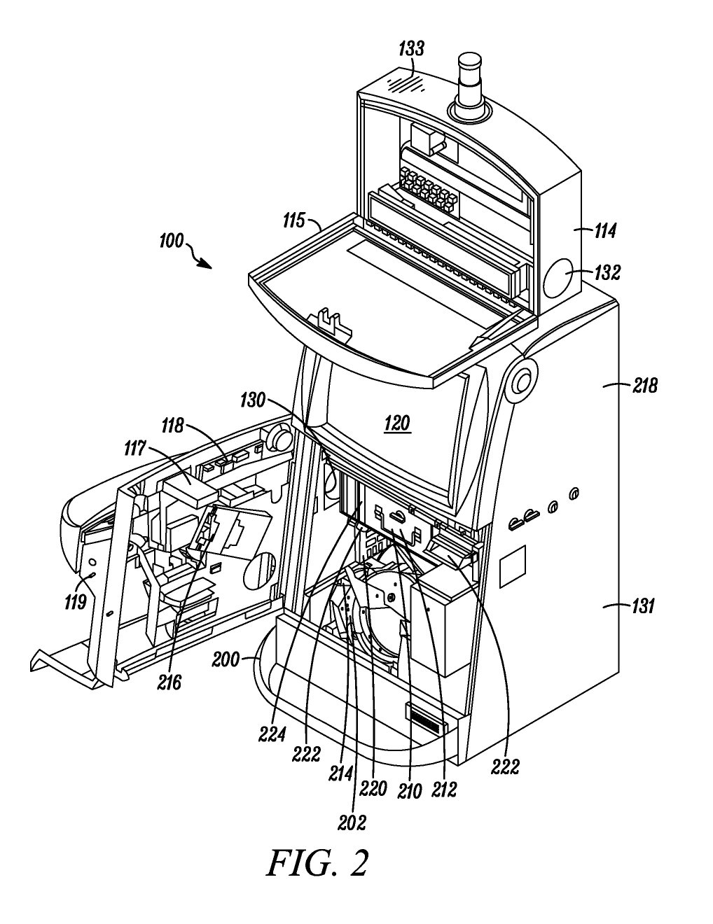

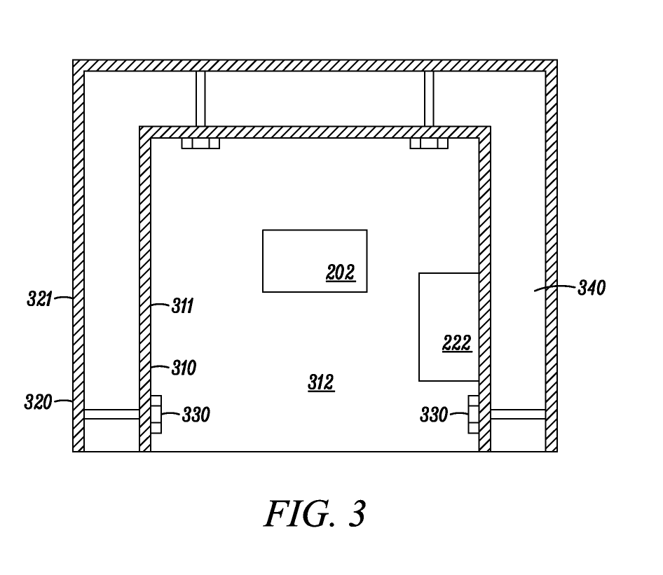

FIG. 1 is a perspective view of an electronic gaming machine 100 that includes a cabinet 208 with a cabinet enclosure 200 which encloses circuitry for gaming 202. The circuitry for gaming 202 includes a computer system 2000 (shown in FIG. 10) and additional components which may or may not be coupled to the computer and under computer control, according to an example embodiment. FIG. 2 is a perspective view of the electronic gaming machine (EGM) 100 with a cabinet door open to reveal the cabinet enclosure 200 and various components therein, according to an example embodiment. Again, the components include the circuitry for gaming 202. Now referring to both FIGS. 1 and 2, the EGM 100 and cabinet enclosure 200 will be further detailed. The cabinet enclosure 200 of the gaming machine 100 includes a housing 110 which has an inner housing 310 and an outer housing 320. The inner housing includes an inner wall 311 and the outer housing 320 includes an outer wall 321. A space or gap 330 (shown in FIG. 3) is located between a substantial portion of the inner wall 311 and the outer wall 321.

The electronic gaming machine 100 includes a top box 112 located above the cabinet enclosure 200. The housing 110 also includes a specialized keyboard 114, which is also termed a player switch panel. The player switch panel is an input/output device that is communicatively coupled to the circuitry for gaming 202 which includes a microprocessor 210 or central processor of the EGM 100. The player input/output or player switch panel 114 is accessible through an outer housing 320 of the EGM 100. The circuitry for gaming 202 includes a brain box that includes the microprocessor 210, a motherboard and memory. The door 116 of the cabinet enclosure 200 is locked during play to prevent or substantially discourage access to the gaming circuitry 202 and other components within the cabinet enclosure 200 of the housing 110. A first monitor 120 is mounted in the door 116 along with a card reader 117, a player tracking display 118 and a door latch 119. Of course, other components are or can be attached to the door 116.

The top box 112 includes a top box door 115 and a second monitor 122. The second monitor 122 is also attached to the top box door 115. The first monitor 120 displays many of the main aspects of the game as the game is played. The user interacts mainly with the first monitor 120 during game play. The second monitor 122 can also display some of the aspects of the game as played. Both monitors display graphics for attracting players while the game is not being played. The top box 112 also includes some components such as a power distribution board 121. The cabinet enclosure 200, as shown by FIG. 2, carries many more components than the top box 112.

Many computer components are within the cabinet enclosure 200. There are also components within the cabinet enclosure 200 that may or may not be under the control of the host computer. The cabinet enclosure 200 includes the central processor 210 on the mother board 212, a communication board assembly 214, an input/output board 216, a power supply 218, and a DC communication board assembly 220. Some of these components are for a typical computer system 2000, such as the one described below in FIG. 10. The cabinet enclosure 200 includes a bill acceptor assembly 222, a service lamp 224, a reset/operator switch 224, a hopper 226 and other components that are not necessarily part of the computer system 2000 (shown in FIG. 10) but are part of the EGM 100. Inputs from these components can be input to the microprocessor 210 or stored in memory associated with the microprocessor 210.

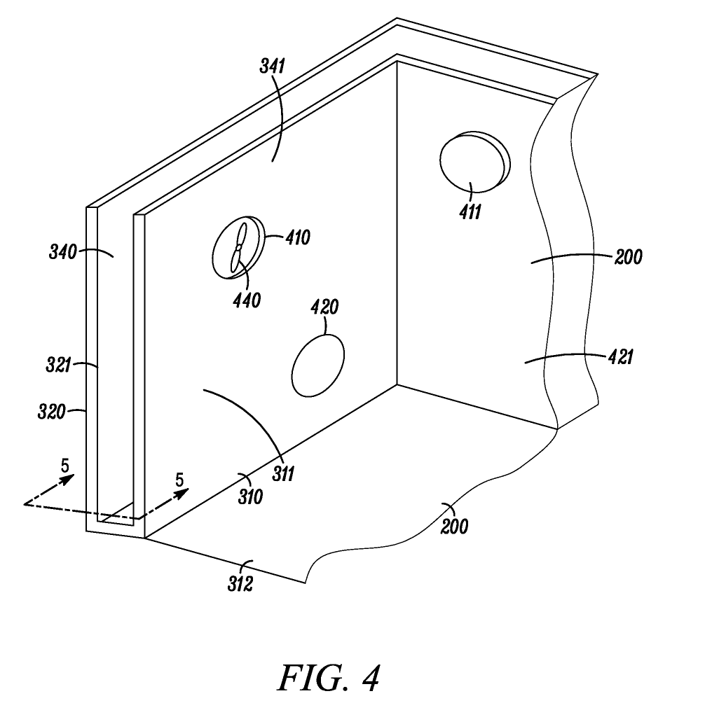

The housing 110 also includes vent openings, which are further detailed in the FIGs. below, which form a flow path through the cabinet enclosure 200. The top box 112 also includes vent opening 132 and 133 which form an air flow path through the top box 112. The vent openings 132 and 133 are generally on the sides and back of the EGM 100 and form one or more air flow paths through the housing and more specifically through an incoming vent, the enclosure, and an outgoing vent. The computer also includes a fan 440 (shown in FIG. 4) which is positioned within the air flow path. The fan 310 is an air handler for increasing the air flow through the housing 110 and past the components that heat during operation. The fan is sized to move a volume of air through the cabinet enclosure 200 and through the top box 114 that can remove an amount of heat from the various heat generating components associated with the gaming circuitry 202 which includes the computer 2000 of the EGM 100 to keep the temperature within the enclosure 200 and the top box 112 down at a level where components will not wear out prematurely due to thermal cycling. In one embodiment, a fixed fan 310 may be used. In another embodiment, a variable speed fan 310 can be used. The variable speed fan 310 can be controlled to reduce air flow during times when the components within the cabinet enclosure 200 and the top box 112 are not being used or are in a low usage state. During such time, less air flow is needed to remove heat. Fans running at a slower speed also are not as noisy. The variable speed fan 310 can also run or be controlled to reduce power consumption.

FIG. 3 is a cross-sectional view of the housing 110 of an electronic gaming machine 100 along cut line 3-3 in FIG. 1, according to an example embodiment. The housing 110 of the enclosure 200 includes an inner housing 310 having an inner wall 311, and an outer housing 320 having an outer wall 321. The inner housing 310 is attached to the outer housing 320 by fasteners 330. The fasteners 330 can include spacers that space the inner housing 310 from the outer housing 320. In one embodiment, the fasteners 330 are bolts. It should be noted that other types of fasteners are contemplated, including latches and detents which would allow for an even faster unfastening of the inner housing 310 from the outer housing 320.

A gap or space 340 is maintained between the inner housing 310 and the outer housing 320. In the embodiment shown, the outer housing 320 includes tapped openings (not shown) which receive a threaded end of the fastener 330. This holds the inner housing 310 with respect to the outer housing 320 without allowing disassembly from the outside for gaining access to the EGM 100. The inner housing 310 also includes a floor 312. Most of the components housed within the inner housing 310 (shown in FIG. 2) are removed from FIG. 3 and replaced with some schematic boxes showing the gaming circuitry 202 and a bill validator 222 for the sake of illustration. Of course, there are other components present in an EGM which are not illustrated here.

FIG. 4 is a perspective view of a wall of an electronic gaming machine that shows a vent opening 410 on the inner wall and a vent opening 420 on an outer wall of a cabinet enclosure 200, according to an example embodiment. The view is from inside the cabinet enclosure 200. The vent opening 410 is distant from the vent opening 420. The vent opening 420 is lower than the vent opening 410. This helps shed liquid should a player spill something on the cabinet 208 of the EGM. So, in the event of a liquid spill on the cabinet, one entry point will be the vent opening 420 in the outer wall 321. If liquid enters the vent opening 420, the liquid will flow to the bottom of the space 340 between the inner housing 310 and the outer housing 320. Gravity will prevent the liquid from flowing up, so the cabinet enclosure will remain substantially dry.

The vent opening 410 in the inner wall 311 is also offset vertically with respect to the vent opening 420 in the outer wall 321 of the outer housing 320. Thus, air can flow through the outer housing 320 through vent opening 420 in the outer wall 321 and into the space 340 between the inner wall 311 and the outer wall 321. The air then flows into the vent opening 410 in the inner wall 311 of the inner housing 310 and to the housing enclosure 200 where the components that generate heat, such as the gaming circuitry 202, is housed. The vents are placed to cool the components within the cabinet enclosure 200. In addition, there are similar vents, such as vent 411 in the back inner wall and vent 421 in the back outer wall to allow the cooling air to exit the cabinet enclosure 200. Again, the vent opening 411 and vent opening 421 are not vertically aligned. In other words, when an EGM is substantially level, the floor of the cabinet enclosure will be substantially horizontal and the walls 311 and 321 will be substantially vertical. The vent openings, such as vent opening 420 and vent opening 410 are not along a vertical line. This makes access to the inside of the disclosure more difficult.

In some embodiments, a barrier or baffle 341 can be placed between the vent openings 420, 410 for one or more purposes. One purpose can be to make it more difficult to gain access to the cabinet enclosure 200 via vent opening 410. Another purpose can be to promote air flow through more of a tortuous path when compared to a line between the air vent 420 and air vent 410. This may promote cooling of the cabinet. It is contemplated that without the barrier or baffle, some or most of the air within the space 340 could be substantially still and serve to insulate the cabinet enclosure 200. The vent openings 410, 411, 420, 421 are also provided with grids to prevent large pieces of material from entering the cabinet. One or more fans or air handlers are provided to move a volume of air through the cabinet enclosure 200 that will carry sufficient amounts of heat to substantially air cool the contents of the enclosure. A fan can be provided at an inlet or at an outlet. In this embodiment, a fan 440 is provided at the inlet and moves air into the opening 420, through the space 340, and into the enclosure 200. The fan pressurizes the enclosure slightly and forces heated air out of another opening in the cabinet, such as vent openings 411, 421. It should be noted that vent openings 411, 421 could be in a wall on the other side of the enclosure as well as the back wall. The vent openings are placed so that the air path through the cabinet enclosure 200 cools the components that generate heat.

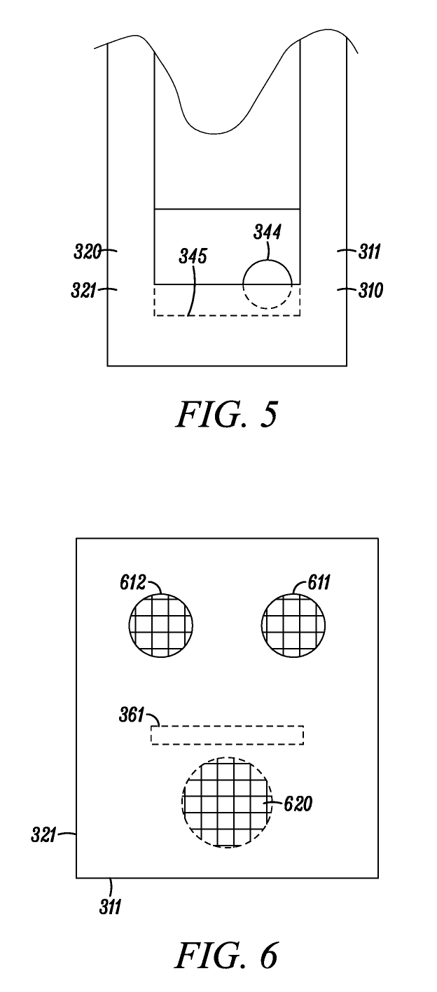

FIG. 5 is a cross-sectional view of the wall of the electronic gaming machine 100 that shows a drain opening 344 for draining fluid from fluid spills from the space between the inner wall 311 and the outer wall 321 of a cabinet, according to an example embodiment. The space 340 includes a floor 345 that slopes toward the drain opening 344. The drain opening 344 includes a portion which is near the floor 344 of the cabinet between the inner wall 311 and the outer wall 321. The floor 345 slopes toward the opening. In the event of a fluid spill, a portion of the fluid can enter an opening in the outer wall 321 and into the space 340. The fluid flows down to the floor 345 and to the drain opening where it exits the EGM relatively harmlessly. A mess may occur near the drain opening. In another embodiment, the drain opening 344 may be provided with a fitting for a drain hose which can carry the fluid to a floor drain or other place for gathering fluid.

FIG. 6 is a side view of an inner wall 311 and an outer wall 321 having vent openings, according to another example embodiment. The inner wall includes vent opening 612 and vent opening 611. The outer wall 311 includes vent opening 620. Vent opening 620 is somewhat larger than the vent openings 611, 612. The vent openings 611, 612 in the inner wall 311 are also offset vertically with respect to the vent opening 620 in the outer wall 321 of the outer housing 320. Thus, air can flow through the outer housing 320 through vent opening 620 in the outer wall 321 and into the space 340 (shown in FIGS. 4 and 5) between the inner wall 311 and the outer wall 321. The air then flows into the vent openings 611, 620 in the inner wall 311 of the inner housing 310 and to the housing enclosure 200 where the components that generate heat, such as the gaming circuitry 202 (shown in FIGS. 2 and 3), is housed. The vents 611, 612 are placed to cool the components within the cabinet enclosure 200. The wall shown could be any wall of the cabinet 208 (shown in FIGS. 1 and 2), such as a side wall or back wall of the cabinet 208. In addition each of the side walls and the back wall could include a similar arrangement of vents. In addition, the vents 611, 612 could be placed closer to the vent 620 if that arrangement is more effective in cooling the heat generating components inside the cabinet enclosure 200. In addition, more vents could be added to the outer wall 321 or to the inner wall 311. Each of the side walls of the cabinet 208 and the back wall of the cabinet 208 need not have the same arrangement of vents. Each could have a different arrangement of vents to facilitate an air flow that cools the heat generating elements within the cabinet enclosure 200. The vent openings 611, 612 and vent opening 620 are not vertically aligned. In other words, when an EGM is substantially level the floor of the cabinet enclosure will be substantially horizontal and the walls 311 and 321 will be substantially vertical. The vent openings, such as vent opening 620 and vent openings 611, 612 are not along a vertical line. This allows the cabinet to handle spills more effectively. Furthermore, this arrangement makes access to the inside of the cabinet 208 more difficult. A baffle or wall 361 is positioned in the space 340 (shown in FIGS. 3-5) between the opening 620 and the openings 611, 612. This serves to cause air flow over more of the inner wall 311 and the outer wall 321 of the housing 110 and also increases the difficulty of gaining access to the cabinet enclosure 200 via the vents 620, 611, and 612. The vents 611, 612, and 620 can be provided with grills to prevent relatively large items from entering the vent openings and getting into the cabinet enclosure 200.

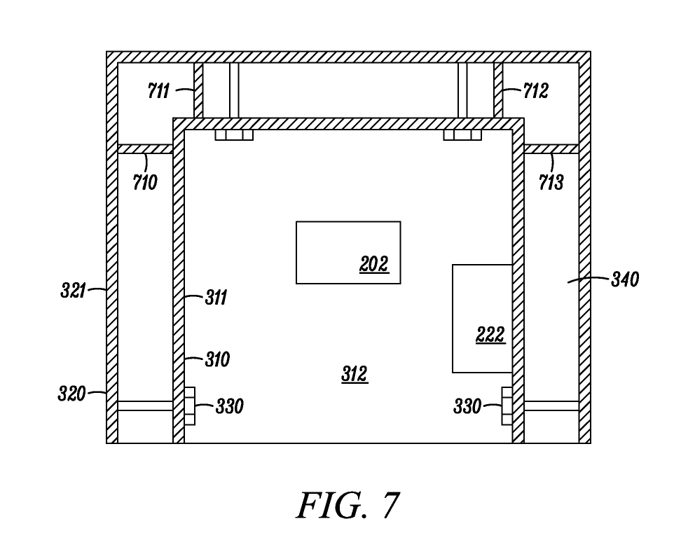

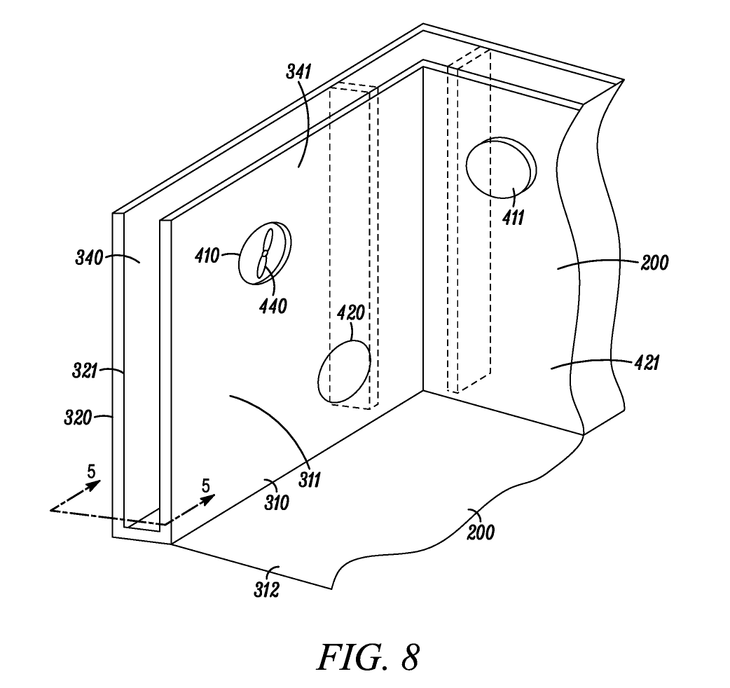

FIG. 7 is a cross-sectional view of the housing of an electronic gaming machine along cut line 7-7 in FIG. 1, according to an example embodiment. FIG. 8 shows a corner of the housing 110, according to an example embodiment. Now referring to both FIGS. 7 and 8, a structure for supporting additional items above a cabinet 208 or top box 112 of a gaming machine 100 as incorporated into the housing 110 will be discussed. More specifically, supports 710, 711 run the length of the housing 110 at a first corner of the housing 110. The supports 710, 711 are located between the inner housing 310 and the outer housing 320. In one embodiment, the supports 710, 711 are attached to the inner wall 311 and to the outer wall 321. The supports 710 and 711 are located within the gap 340 between the inner housing 310 and the outer housing 320. The EGM shown is situated on a solid base so that there is no need to run these supports into the base. It is contemplated that in other EGMs, such as an upright machine, the supports could be run through the base of such a machine. The supports 712, 713 are also the second corner of the housing 110. These supports are not shown in FIG. 8 but have a similar structure to the supports 710, 711 shown in FIG. 8 and described above. Depending on the EGM, the supports 710, 711, 712, 713 could be continued through the top box. As shown, the outer housing 320 and the inner housing 310 operate as portions of a structural support 700.

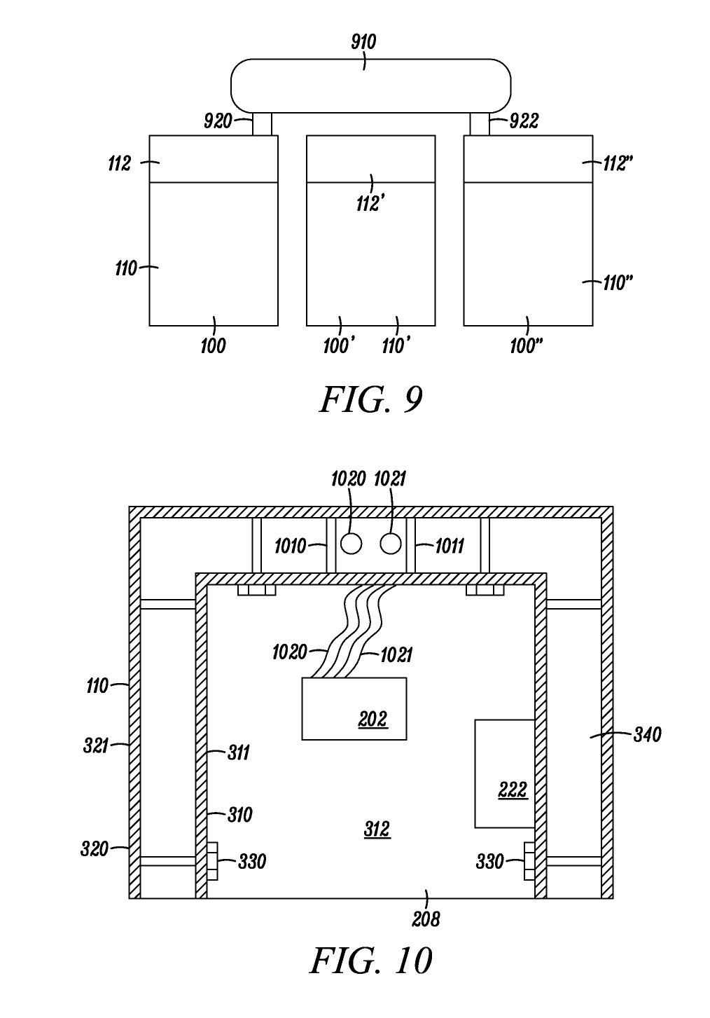

FIG. 9 shows a front view of several EGMs 100, 100′, 100″ that have supports, such as supports 710, 711, 712, 713 incorporated into the housing 110, 110′, 110″ and into the top boxes 112, 112′, 112″, according to an example embodiment. The corners of the EGMs 100, 100′, 100″ can now support another item, such as signage 910 on posts 920, 922 above the EGMs 100, 100′, 100″. In the past the posts ran to the floor and were located between the EGMs 100, 100′, 100″. In this embodiment, the posts 920 are shorter which lessens the load that needs to be installed. More importantly, the EGMs 100, 100′, 100″can be more closely spaced. This will allow a casino to fit more EGMs or other gaming devices onto a casino floor and result in increased revenues for the casino since more gaming opportunities are presented to players. The arrangement also allows the casino to save on materials since the posts can now be shortened.

FIG. 10 is another top cross-sectional view along cut line 7-7 of FIG. 1 which shows a wire routing structure 1000 in the housing 110 of the cabinet 208, according to an example embodiment. The wire routing structure includes two cross walls 1010, 1011 between the inner wall 311 and the outer wall 321 of the housing 110. The wires or cables 1020, 1021 that need to be routed to the top box 112 (shown in FIGS. 1, 2 and 9) can be run between the interior wall 311 associated with the inner housing 310, the outer wall 321 associated with the outer housing 320, the cross wall 1010, and the cross wall 1011. In other words, the cross walls 1010, 1011, a portion of the inner wall 311, and a portion of the outer wall 321 form a cable raceway or cable routing structure 1000. Cables or wires 1020, 1021 are connected or coupled to the gaming circuitry 202, then routed up the cable raceway or through the cable routing structure 1000 to an opening in the bottom of the top box 112 (shown in FIGS. 1, 2, and 9). The cables 1020, 1021 are not exposed between the cabinet 208 and the top box 112. When servicing components in the top box 112, the technician will have access to the cables 1020, 1021 without having to open the cabinet 208. The cable raceway 1000 makes the cables more secure and also can make servicing of the top box easier. The cables, in one embodiment, terminate in a connector in the top box.

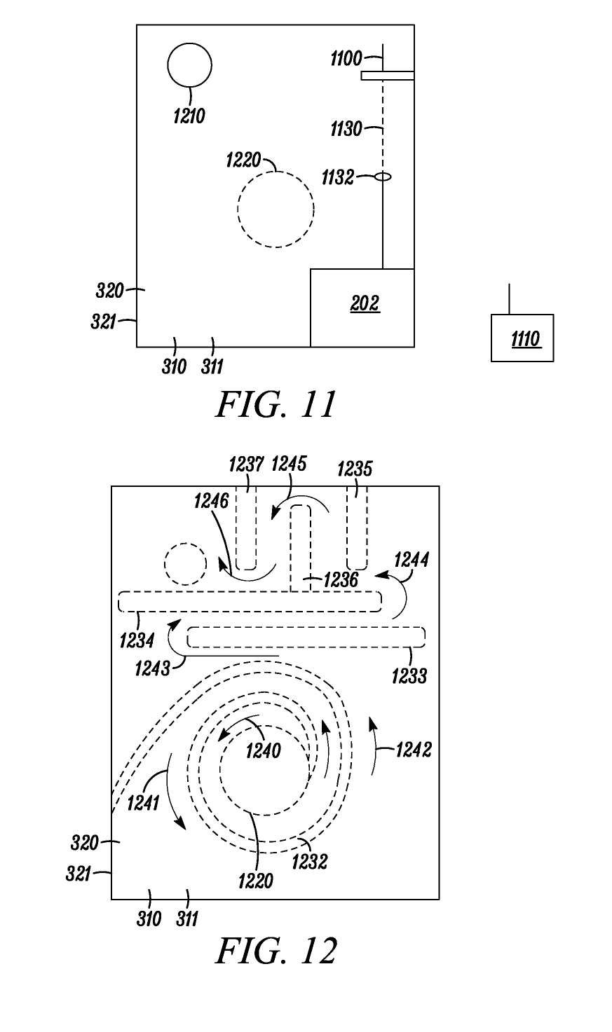

FIG. 11 is side view of a wall of the housing 110 of the cabinet 208, wherein the gap between the inner wall 311 and the outer wall 321 includes an antenna 1100 for wireless communication with external circuitry 1110, according to an example embodiment. The antenna 1100 is located between the inner housing 310 and the outer housing 320. The antenna sits on a ledge 1120 located between the inner housing 310 and the outer housing 320. The antenna is coupled to the gaming circuitry 202 by wire 1130 attached to the antenna 1100 at one end and to gaming circuitry 202 on the other end. The wire passes through the inner wall 311 at opening 1132. The antenna 1100 is positioned so that it can communicate with external circuitry 1110, such as a hand held or laptop computer used by a technician. It could also broadcast information to a specialized computer passing by or to a secure local area network associated with the owner or maintainer of the EGMs 100 (shown in FIGS. 1 and 2). In one embodiment, the antenna could even be incorporated into the wall structure or formed with either the inner housing 310 or the outer housing 320. The inner wall has a vent opening 1210 therein and the outer wall has an opening 1220 therein.

FIG. 12 is side view of a wall of the housing 110 of the cabinet, wherein the gap between the inner wall and the outer wall includes a cooling system 1230, according to an example embodiment. The inner wall has a vent opening 1210 therein and the outer wall has an opening 1220 therein. The cooling system 1230 includes a plurality of walls for directing fluid flow through the gap 340 (shown in FIG. 3) between the inner wall 311 and the outer wall 321 of the housing 110. The fluid used in this embodiment is air. Other fluids could be used. More specifically, the walls of the cooling system include a spiral wall 1232 which directs fluid flow around the vent opening as indicated by directional arrows 1240, 1241, and 1242. A wall 1233 directs fluid flow across the gap as indicated by directional arrow 1243. Another wall, 1234 directs fluid flow across the gap again, as indicated by directional arrow 1244. Several other walls 1235, 1236 and 1237 direct fluid flow in a serpentine manner as indicated by directional arrows 1245 and 1246. Movement of the fluid over the inner wall 310 and the outer wall 320 cool the housing 110. This is one embodiment. It is also contemplated that another embodiment could include providing channels for another fluid within the gap. Water could be circulated in a water jacket formed in the gap. In still another embodiment, the gap could house a refrigerant used in a Rankin cycle to cool the housing 110. In other words, the wall would become the part of a refrigerator that cools the gaming circuitry rather than food. The tortuous path indicated by the arrows 1240-1246 could be considered a shroud or duct between the vent opening 1220 and the vent opening 1210.

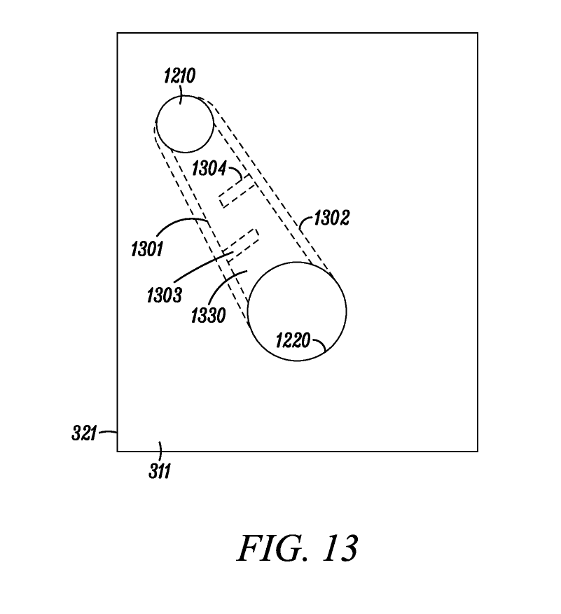

FIG. 13 is side view of a wall of the housing 110 of the cabinet, wherein the gap between the inner wall and the outer wall includes a duct 1330, according to an example embodiment. The duct 1330 includes a first wall 1301 which serves as one side of the duct 1330, and a second wall 1302 that serves as another side of the duct 1330. Portions of the inner wall 311 and the outer wall 321 which face the gap 340 (shown in FIG. 3) complete the duct 1330. The duct 1330 also includes a third wall 1303 and a fourth wall 1304 to deter people attempting to gain access to the cabinet enclosure 200 (shown in FIG. 2) via the duct.

In still other embodiments, the gap 340 is open at the top of the cabinet 208 so that heat may be drawn from a component within the inside the cabinet 208 or within the inner housing 310 and directed to the gap 340 between the inner housing 310 and the outer housing 320. In other words, the gap will include openings that allow heat to be vented to the exterior so that the gap can act as a chimney through which heated air flows and exits the EGM 100. In another embodiment, the top box 114 has openings therein which form a continuation of the gap 340 between the inner housing 310 and the outer housing 320 of the cabinet 100. The exhaust air from the cabinet 208 and in the gap 340 can be used to further cool heat producing elements in the top box 114. In another embodiment, the outer wall 321 of the outer housing 320 is provided with inlet openings for cooling air. The cooling air enters these inlet openings and is routed to the top box 114 to cool components within the top box 114. In other words, in some embodiments, there is not an exact match between the cooling air inlets and the heated air exhaust vents. The gap 340 or the continuation of the gap in the top box 114 is employed similar to a chimney or exhaust fans can be placed to increase the flow of air through the gap 340 and through the top box 114.

The gaming electronics 202 within the enclosure 200 includes a component that is provided with an exhaust fan. Many microprocessors include their own exhaust fan to keep the microprocessor cool and prevent thermal failure of the micropocessor. In one embodiment, an exhaust port is provided in the inner wall 321 near the fan of the microprocessor. The warmed air from the microprocessor exits the side wall 311 through the exhaust port into the gap 340 of the cabinet 208. The exhaust port is generally located near the microprocessor. The warm air is placed into the gap 340 and exits the top of the cabinet 208 at the top of the gap 340.

In still another embodiment, an inlet for air is provided on the exterior wall 321 of the cabinet. A duct can be provided to such an inlet. The duct passes through the interior gap 340 between walls 311 and 321 of the cabinet 208. The duct exits to the exterior of the cabinet. Such a duct could be used to route wiring to signage 910 (see FIG. 9) above the EGM 100, 100′, 100″. A sign installer could route wiring from the machine stand on which the EGM 100, 100′, 100″ sits, to the signage 910. The routed wiring is hidden within the double wall or gap 340 of the cabinet 208 of the EGM 100, 100′, 100″

In still further embodiments, ducts could be provided within the enclosure 200 of the cabinet 208 to direct cooling air or heated air to various inlets or outlets associated with the cabinet 208.

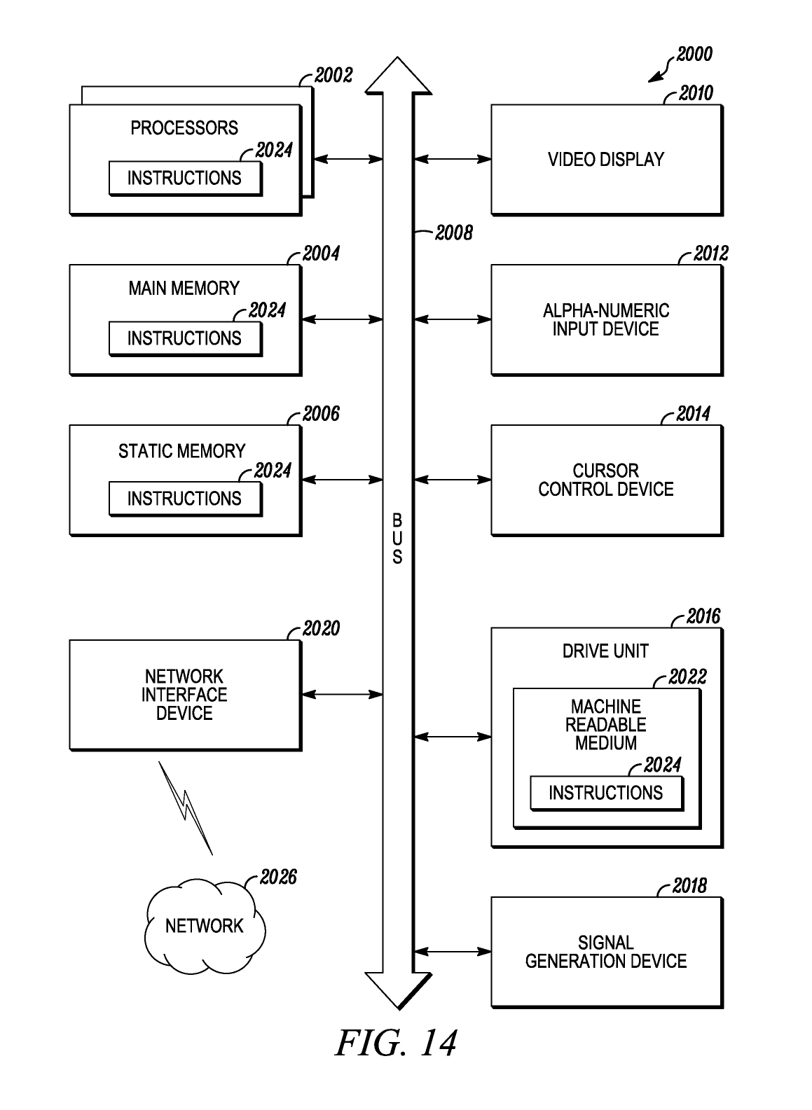

FIG. 14 shows a diagrammatic representation of a computing device for a machine in the example electronic form of a computer system 2000, within which a set of instructions for causing the machine to perform one or more gaming operations or control functions for the EGM 100 are stored for execution by the computer system. The computing system can also operate and send information to be conveyed to external circuitry, such as external circuitry 1110 via antenna 1100. In various example embodiments, the machine operates as a standalone device or can be connected (e.g., networked) to other machines. In one embodiment, the computer system includes the gaming circuitry 202 discussed above. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a Personal Digital Assistant (PDA), a cellular telephone, a portable music player (e.g., a portable hard drive audio device such as an Moving Picture Experts Group Audio Layer 3 (MP3) player, a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2000 includes a processor or multiple processors 2002 (e.g., a central processing unit (CPU), a graphics processing unit (GPU), arithmetic logic unit or all), and a main memory 2004 and a static memory 2006, which communicate with each other via a bus 2008. The computer system 2000 can further include a video display unit 2010 (e.g., a liquid crystal displays (LCD) or a cathode ray tube (CRT)). The computer system 2000 also includes an alphanumeric input device 2012 (e.g., a keyboard), a cursor control device 2014 (e.g., a mouse), a disk drive unit 2016, a signal generation device 2018 (e.g., a speaker) and a network interface device 2020.

The disk drive unit 2016 includes a computer-readable medium 2022 on which is stored one or more sets of instructions and data structures (e.g., instructions 2024) embodying or utilized by any one or more of the methodologies or functions described herein. The instructions 2024 can also reside, completely or at least partially, within the main memory 2004 and/or within the processors 2002 during execution thereof by the computer system 2000. The main memory 2004 and the processors 2002 also constitute machine-readable media.

The instructions 2024 can further be transmitted or received over a network 2026 via the network interface device 2020 utilizing any one of a number of well-known transfer protocols (e.g., Hyper Text Transfer Protocol (HTTP), CAN, Serial, or Modbus).

While the computer-readable medium 2022 is shown in an example embodiment to be a single medium, the term “computer-readable medium” should be taken to include a single medium or multiple media (e.g., a centralized or distributed database, and/or associated caches and servers) that store the one or more sets of instructions and provide the instructions in a computer readable form. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, tangible forms and signals that can be read or sensed by a computer. Such media can also include, without limitation, hard disks, floppy disks, flash memory cards, digital video disks, random access memory (RAMs), read only memory (ROMs), and the like.

The example embodiments described herein can be implemented in an operating environment comprising computer-executable instructions (e.g., software) installed on a computer, in hardware, or in a combination of software and hardware. Modules as used herein can be hardware or hardware including circuitry to execute instructions. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method(s) can be written in any number of suitable programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

A method for maintaining an electronic gaming includes removing the inner housing 310 from the outer housing 320 and placing a replacement inner housing 310 into the outer housing 310. Peripheral devices outside the inner housing 310 are coupled to the gaming circuitry 202. Removing the inner housing includes uncoupling fasteners 330 from the outer housing 320. The fasteners can include bolts which thread into threaded openings in the outer housing 320. Threaded inserts can also be attached or inserted into the outer wall 321 to provide the threads into which a bolt can fasten. Other arrangements for attaching the inner housing 310 to the outer housing 320 include quick connect latches which allow the inner housing 310 to be disconnected from the outer housing 320 by unlatching at least one latch.

Once unlatched, a replacement inner housing 310 populated with comparable gaming circuitry 202 for the particular EGM can be placed into the outer housing 320 of the EGM. Peripherals outside the inner housing 310 can be coupled to the comparable gaming circuitry 202 and fastened to the outer housing 320. The inner housing that was replaced can then be taken to a work bench or other area where repairs, software updates, or other maintenance can be facilitated. In this way, downtime of EGMs on a casino floor can be lessened. Furthermore, customers see the EGM as being up for a greater amount of time which builds the reputation of a gaming establishment as having EGMs that are reliable.

A gaming machine includes an outer housing and an inner housing. The outer housing includes a first wall having a first ventilation port in fluid connection exterior to the outer housing. The inner housing within the outer housing includes a second wall including a second ventilation port. The second ventilation port is offset from the first ventilation port. The gaming machine also includes a player input/output accessible through the outer housing, and circuitry for gaming within the inner housing and operably connected to the player input/output. The first ventilation port and the second ventilation port are connected by a duct to convey fluid. In one embodiment, the first ventilation port is positioned rearwardly of the second ventilation port. In another embodiment, the first ventilation port is positioned downwardly of the second ventilation port. The outer housing and the inner housing form a gap therebetween, the gap providing at least one of liquid protection for the circuitry for gaming or air flow for the circuitry for gaming. The inner housing includes a fan to draw air from through the first ventilation port from outside the outer housing into the gap between the outer housing and the inner housing. The air is then drawn into the inner housing through the second ventilation port. The fan also moves the air or fluid through the housing and out the inner housing and outer housing. In one embodiment, the gap between the inner housing and the outer housing includes a raceway to hold wiring. The gap also includes a cooling system, in some embodiments. The gap can also include an antenna for wireless communication with external circuitry. In some embodiments, the outer housing and the inner housing both operate as structural supports.

In one embodiment, the first ventilation port has fewer apertures than the second ventilation port. In some embodiments, the first wall and the second wall do not face each other. The first wall is positioned on a side or rear of the gaming machine. In another embodiment, the second wall is positioned on a side or front of the gaming machine.

A gaming machine includes an outer housing including side walls, an inner housing being fixed within the outer housing, a player input/output being accessible through the outer housing, and circuitry for gaming within the inner housing and operably connected to the player input/output. The outer housing has at least one side wall having a first inlet in fluid connection exterior to the outer housing, and at least one side wall having a first internal ventilation port in fluid connection with the first inlet. The first internal port is offset from the first inlet in the outer housing. The inner housing includes a second internal ventilation port and third internal ventilation port. The second port and the third port are offset from the first port and offset from each other.

The cabinet 208 includes the housing 100 of the EGM cabinet which has an outer housing 320 including a first wall 321 and an inner housing 310 within the outer housing 320. The inner housing 310 includes a second wall 311 in spaced relation with respect to the first wall 321. At least one cable routing structure 1000 is positioned between the inner housing 310 and the outer housing 310. The electronic gaming machine 100 includes circuitry for gaming 202 within the inner housing 310. A peripheral device is attached to the gaming circuitry 202 and is outside the cabinet. The peripheral device is coupled to the gaming circuitry 202 by at least one cable routed through the at least one cable routing structure 1000. In one embodiment, the electronic gaming machine includes a top box attached to the cabinet. The top box includes at least one peripheral device operably connected to the circuitry for gaming with the at least one cable. The cable coupling the peripheral device and the circuitry for gaming is substantially inaccessible from the exterior of the cabinet and top box. The cable 1020 is accessible from the interior of the top box and from the interior of the inner housing. In one embodiment, connectors to the cable are provided in the top box and in the inner housing so that the cable 1020 can remain in place if inner housing 310 is removed from the outer housing 320. The electronic gaming machine further comprises a player input/output operably connected to the circuitry for gaming 202. The player input/output is accessible through the outer housing 320. The peripheral device associated with the top box can be a display, an attractor device, an antenna for relaying information, or the like.

The cable routing structure includes a portion of the first wall and a portion of the second wall. In some embodiments, the routing structure further comprises a third wall connecting the first wall and the second wall. In still further embodiments, the cable routing structure includes a fourth wall connecting the first wall and the second wall. The third wall is spaced from the fourth wall. The second wall includes an opening therein that is positioned to access the routing structure.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

While the embodiments have been described in terms of several particular embodiments, there are alterations, permutations, and equivalents, which fall within the scope of these general concepts. It should also be noted that there are many alternative ways of implementing the methods and apparatuses of the present embodiments. It is therefore intended that the following appended claims be interpreted as including all such alterations, permutations, and equivalents as fall within the true spirit and scope of the described embodiments.

1. A gaming machine, comprising:
an outer housing including a first wall having a first ventilation port in fluid connection exterior to the outer housing;
an inner housing within the outer housing, the inner housing includes a second wall including a second ventilation port, the second ventilation port being offset from the first ventilation port;
a player input/output being accessible through the outer housing;
circuitry for gaming within the inner housing and operably connected to the player input/output.

2. The gaming machine of claim 1, wherein the first ventilation port and the second ventilation port are connected by a duct to convey fluid.

3. The gaming machine of claim 1, wherein the first ventilation port is positioned rearwardly of the second ventilation port.

4. The gaming machine of claim 1, wherein the first ventilation port is positioned downwardly of the second ventilation port.

5. The gaming machine of claim 1, wherein the outer housing and the inner housing form a gap therebetween, the gap providing at least one of liquid protection for the circuitry for gaming or air flow for the circuitry for gaming.

6. The gaming machine of claim 5, wherein the inner housing includes a fan to draw air through the first ventilation port from outside the outer housing into the gap, into the inner housing through the second ventilation port and out the inner housing and outer housing.

7. The gaming machine of claim 5, wherein the gap includes a raceway to hold wiring.

8. The gaming machine of claim 5, wherein the gap includes a cooling system.

9. The gaming machine of claim 5, wherein the gap includes an antenna for wireless communication with external circuitry.

10. The gaming machine of claim 1, wherein the outer housing and the inner housing both operate as structural supports.

11. The gaming machine of claim 1, wherein the first ventilation port has fewer apertures than the second ventilation port.

12. The gaming machine of claim 1, wherein the first wall and the second wall do not face each other.

13. The gaming machine of claim 11, wherein the first wall is positioned on a side or rear of the gaming machine.

14. The gaming machine of claim 13, wherein the second wall is positioned on a side or front of the gaming machine.

15. A gaming machine, including:
an outer housing having side walls, at least one side wall having a first inlet in fluid connection exterior to the outer housing, at least one side wall having a first internal ventilation port in fluid connection with the first inlet, the first internal port being offset from the first inlet;
an inner housing being fixed within the outer housing and including a second internal ventilation port and third internal ventilation port, the second port and third port being offset from the first port and each other;
a player input/output being accessible through the outer housing;
circuitry for gaming within the inner housing and operably connected to the player input/output.

16. A gaming machine, comprising:
a cabinet having a housing further comprising:
an outer housing including a first wall;
an inner housing within the outer housing, the inner housing includes a second wall in spaced relation with respect to the first wall;
at least one cable routing structure positioned between the inner housing and the outer housing;
circuitry for gaming within the inner housing;
a peripheral device outside the cabinet;
at least one cable routed through the at least one cable routing structure, the cable operably coupling the circuitry for gaming and a peripheral device outside the cabinet.

17. The gaming machine of claim 16, wherein the gaming machine further comprises a top box attached to the cabinet, the top box including at least one peripheral device operably connected to the circuitry for gaming with the at least one cable, the cable coupling the peripheral device and the circuitry for gaming substantially inaccessible from the exterior of the cabinet and top box.

18. The gaming machine of claim 16, wherein the gaming machine further comprises a top box attached to the cabinet, the top box including at least one peripheral device operably connected to the circuitry for gaming with the at least one cable, the cable coupling the peripheral device and the circuitry for gaming substantially inaccessible from the exterior of the cabinet and the exterior of the top box, the cable accessible from within the top box.

19. The gaming machine of claim 16, wherein the gaming machine further comprises a player input/output being accessible through the outer housing, the player input/output operably connected to the circuitry for gaming.

20. The gaming machine of claim 18, wherein the peripheral device associated with the top box is a display.

21. The gaming machine of claim 18, wherein the peripheral device associated with the top box is an attractor device.

22. The gaming machine of claim 16, wherein the cable routing structure includes a portion of the first wall and a portion of the second wall.

23. The gaming machine of claim 22, wherein the routing structure further comprises a third wall connecting the first wall and the second wall.

24. The gaming machine of claim 22, wherein the routing structure further comprises:
a third wall connecting the first wall and the second wall; and
a fourth wall connecting the first wall and the second wall, the third wall spaced from the fourth wall.

25. The gaming machine of claim 16 wherein the second wall includes an opening therein, the opening positioned to access the routing structure.

26. A method for maintaining an electronic gaming machine having an outer housing positioned within an inner housing, the inner housing including gaming circuitry which includes a microprocessor, memory and a plurality of peripheral devices coupled to the microcontroller, the method comprising:
removing the inner housing from the outer housing; placing a replacement inner housing into the outer housing; and
coupling the peripheral devices outside the inner housing to the gaming circuitry.

27. The method of claim 26 wherein removing the inner housing includes uncoupling fasteners from the outer housing.

28. The method of claim 26 wherein removing the inner housing includes unlatching the inner housing from the outer housing.

29. A gaming machine, comprising:
an outer housing including a first wall;
an inner housing within the outer housing, the inner housing positioned within the outer housing to form a gap between the inner housing and the outer housing, the inner housing including a second wall with a ventilation port to the gap;
a player input/output being accessible through the outer housing; and
circuitry for gaming within the inner housing and operably connected to the player input/output.

30. The gaming machine of claim 29 wherein the outer housing includes openings proximate the top of the gap to allow air to escape from the gap.

31. A gaming machine, comprising:
an outer housing including a first wall;
an inner housing within the outer housing, the inner housing includes a second wall, the first wall and the second wall forming a passageway located between the second wall of the inner housing and the first wall of the outer housing;
a player input/output being accessible through the outer housing;
circuitry for gaming within the inner housing and operably connected to the player input/output.
